(19) United States
(12) Patent Application Publication
(10) Pub. No.: US 2002/0167860 A1
(43) Pub. Date: Nov. 14, 2002

(54) Apparatus for industrial mixing of materials in a mixing vessel and for industrial expulsion of the in particular viscous or pasty mixed product

(76) Inventors: Bruno Buob, Andwil (CH); Urs Fischer, Oberaach (CH)

Correspondence Address: BIRCH STEWART KOLASCH & BIRCH, PO BOX 747, FALLS CHURCH, VA, 22040-0747, US

(21) Appl. No.: 10/123,221

(22) Filed: Apr. 17, 2002

(30) Foreign Application Priority Data
Apr. 17, 2001 (EP) 01 810 380.4

(51) Int. Cl. B29B 7/06

(52) U.S. Cl. 366/77; 366/96

(57) ABSTRACT

The apparatus is used for industrial mixing of in particular viscous or pasty materials in a mixing vessel (1) and for industrial expulsion of the mixed product produced from this vessel (1). The mixing vessel (1) is closed by a bottom part (3) and a top part (5) opposite the latter. In the mixing vessel (1) there is a movable mixing tool (9) whose position can be varied. The mixing vessel (1) is arranged approximately horizontally and through the top part (5) there extends a linear guide (7) with which the mixing tool (9) can be moved, varying its position. The bottom part (3) is designed to be displaceable towards the top part (5) in order to expel the mixture in the vessel (1).

The apparatus according to the invention operates without faults, since, although the unit for mixing the materials and the unit for expelling the mixed product are arranged in one and the same mixing vessel, they are designed to be separated unambiguously from each other.

### TECHNICAL FIELD

The invention relates to an apparatus according to the precharacterizing clause of patent claim 1.

An apparatus for industrial mixing and industrial expulsion of materials is understood to mean an apparatus which, as a rule, is not used in a laboratory operation, in which quantities of at most a few kilograms are processed. Industrial is understood to mean quantities or weights of material which lie above those of a conventional laboratory operation, that is to say begin at a few tens of liters or kilograms and extend into tonnes or hectoliters.

### PRIOR ART

EP 0 196 291 describes a mixing and expressing apparatus for mixing viscous or pasty masses, which could be used industrially. In the case of the known mixing apparatus, a rotatably mounted mixer shaft with a mixing tool was arranged in a mixing vessel and was additionally axially movable. The vertically arranged mixer shaft passed centrally through a pressure plate, which was likewise axially movable on this shaft in order to expel the mixed product. The pressure plate was provided with seals with respect to the mixer shaft and with respect to the circularly cylindrical inner wall of the mixing vessel. An outlet for the mixed product to be expressed by the pressure plate was arranged in the bottom of the mixing vessel.

In operation, the known mixing and expressing apparatus was extremely susceptible to faults and tended generally to leaks, in particular during the expression.

In WO 93/23156, an apparatus for mixing viscous or pasty materials is described. Using the apparatus, small quantities of ointments, pastes, creams, gels and emulsions could be mixed. The mixing vessel could not be heated and had a screw cover with a single central opening, through which a shaft with a vaned stirrer extended. The shaft could be rotated in the central opening and was held such that it could be displaced in the direction of the longitudinal axis of the vessel, located vertically. After the screw cover had been unscrewed, the shaft could be removed from the central opening and a so-called applicator could be inserted into the opening. The bottom of the vessel could be designed such that it could be displaced in the longitudinal axial direction of the vessel by the applicator in order to press the mixed material out.

EP-A 1 020 167 describes an apparatus for mixing small quantities of viscous or pasty materials [bone cement]. The mixed product could be acted on by vacuum. The mixing vessel was vertical. Mixing was carried out by moving a slide with a mixing element up and down manually. In order to expel the mixture, the bottom could be moved in an upward movement towards the top. The air in the mixing vessel could be let out via openings in the top part; the vacuum was likewise applied via the top part.

DE-A 197 35 539 discloses an unheatable stirred vessel, to be used for laboratory operation, as an apparatus for mixing small quantities of viscous or pasty materials. The intention here, whilst avoiding the inlet of air to the mixed product, is to produce ointments, mixtures, suspensions or emulsions for medical or cosmetic applications. The stirred vessel was upright and had a bottom part and a top part, it being possible for the shaft of the stirring tool to be guided centrally through the bottom or the top part. The shaft was of hollow design; the mixed product was expelled through the internal bore, by the bottom being pressed into the vessel as a piston. Material could be introduced into the vertical stirred vessel through an opening in the bottom, in the jacket or in the top.

EP-A 0 796 653 describes a further mixing apparatus for producing small quantities of bone cement for direct treatment use. The apparatus had a mixing tool extending through the top part of the vessel. Here, too, as in the case of DE 197 35 539, EP 1 020 167 and WO93/23156, the bottom was designed in the manner of a piston in order to expel the mixed product. A vacuum pump could be connected via the top.

### SUMMARY OF THE INVENTION

### OBJECT OF THE INVENTION

It is an object of the invention to provide an apparatus for industrial mixing of in particular viscous and pasty materials in a mixing vessel and for industrial expulsion of the mixed product produced from this vessel which, as opposed to that of EP 0 196 291, operates without faults.

### ACHIEVEMENT OF THE OBJECT

According to the invention, the object is achieved in that here, as opposed to EP 0 196 291, although the unit for mixing the materials and the unit for expelling the mixed product are arranged in one and the same mixing vessel, they are designed to be separated unambiguously from each other. This is because, according to the invention, only a linear guide with a mixing tool arranged on it extends through the top part. The expulsion of the mixed product is performed independently of the mixing arrangement by means of a bottom part acting as a piston. The units used for the mixing and the units used for the expulsion are completely mechanically separated from one another, apart from an outlet nozzle in the top part.

Examples of suitable mixed products are, for example, sealing compound, PVC plastisols, reactive adhesives based on PUR, epoxides and acrylates, structural adhesives, emulsion paints and varnishes.

The apparatus according to the invention is used for industrial mixing of in particular viscous and pasty materials in a mixing vessel and for industrial expulsion of the mixed product produced from this vessel. As opposed to the known apparatuses from EP-A 0 196 291, WO 93/23156, EP-A 1 020 167, DE-A 197 35 539 and EP 0 796 653, acknowledged above, the axis of the mixing vessel and, with it, the “mixer shaft” is no longer vertical but approximately horizontal. An approximately horizontal position is thought of as opposed to a vertical position. Approximately horizontal is also understood to mean positions which deviate from the horizontal, for example by up to 30°. However, anything which has an angle greater than 45° from the horizontal is no longer viewed as approximately horizontal here.

A vertical position may certainly have been copied by generally known mixing vessels. However, the horizontal position is unfamiliar to those skilled in the art, but, in the case of industrial mixing apparatus and plants, results in very easy servicing, since the components, as shown for example in FIG. 3 of the application, can be moved apart from one another in a horizontal plane. Large cranes are therefore generally no longer required for servicing work.

In addition, the horizontal construction permits an efficient procedure in the production of medium- to high-viscosity and also reactive products. With a minimum expenditure of energy, in a closed system and a gentle process, a homogeneous mixture is produced. Just a solid floor is sufficient as a standing area for the apparatus.

By means of this arrangement, an extremely stable mounting of the axially displaceable mixer shaft and also relatively constructionally simple, comprehensible and therefore cleanly acting sealing from the outside can be performed. In addition, the bottom part serving for the expression can now be configured to be very stable and secure against tilting.

The apparatus with its mixing vessel and the associated drive elements for the expression, the axial displacement of the mixer shaft and the movements of the mixing tool can be arranged in a linear structure, in a horizontal position, upright or horizontally; preferably, however, a horizontal erection will be selected. By means of horizontal erection—the geometric axis of the mixing vessel is approximately horizontal; the axial displacements are likewise carried out approximately horizontally—maintenance of the apparatus can be carried out significantly more simply than in the case of an apparatus standing vertically, which would need structures like scaffolding. All the elements and units can therefore be reached from the floor without scaffolding, possibly with a small staging.

Since the expression of the mixed product is now carried out by moving the bottom part in the direction of the top part, the top part is provided in a stationary manner with an outlet opening for the mixed product. The stationary top part will preferably also be provided with inlets for the materials to be mixed; in addition, all the further connections, for example for the application of vacuum or pressure, will be fitted to the top part. There is then only a single location to which all the lines have to be led. For cleaning and servicing purposes, the top part will preferably be designed such that it can be removed, preferably moved away, from the mixing vessel (on account of the great weight).

In order to express the mixed product, the bottom part can be moved in the manner of a piston in the interior of the mixing vessel, which then constitutes the cylinder wall for the piston. Although the bottom part has a seal in the edge region, the cylinder wall is also of sufficiently smooth design; however, it may always occur that residues of mixed product remain adhering during the movement of the piston in the direction of the top part and slip through the seal. In order that the minimum residues cannot react with surrounding air, possibly undergoing curing, there is a covering hood. During the expulsion of the mixed product, this covering hood seals off from the outside the interior of the vessel being freed by the moving bottom part. In addition, in the region of the covering hood, there is an inlet for, preferably, an inert gas, in order to be able to flood the space between the hood and bottom part.

The lateral vessel wall is configured in such a way that it can be subjected to a temperature to be predefined. Depending on the mixed product or materials to be mixed, it is thus possible for a temperature selected above or below the ambient temperature to be predefined. The application of the temperature will preferably be performed by a heat-transfer medium circulating in the vessel wall. In this case, the medium can flow in pipelines laid in the wall; it is also possible to provide a double wall with an interspace.

Although any desired cross section of the interior of the mixing vessel can be chosen, for simplicity a circularly cylindrical one will be chosen. In the case of a circularly cylindrical cross section there are no corners in which material which has not been thoroughly mixed could remain.

Both the bottom part acting as piston and the mixing tool are preferably designed to be secured against rotation and tilting. Securing in this way can be achieved by means of at least one further shaft arranged off-centre in relation to the shaft acting axially. Provision will preferably be made not just of one additional off-centre shaft but of two shafts located opposite each other or three or more at the same angular spacing.

In order that as little as possible, that is to say even no, mixed product remains adhering to the walls of the interior of the mixing vessel, nor to the axially movable mixer shaft, during the expression, purged seals are used there.

### BRIEF DESCRIPTION OF THE DRAWINGS

In the following text, examples of the apparatus according to the invention will be explained in more detail using the following drawings. Further advantages of the invention emerge from the descriptive text. In the drawings:

FIG. 1 shows a side view of the apparatus according to the invention,

FIG. 2 shows a plan view of the apparatus shown in FIG. 1, the mixing vessel being illustrated in section,

FIG. 3 shows an illustration analogous to FIG. 1, but with the top part of the apparatus being located in a servicing or cleaning position, removed from the mixing vessel,

FIG. 4 shows an illustration of the apparatus, analogous to FIG. 2, with the top part moved in a manner analogous to FIG. 3,

FIG. 5 shows a plan view of the top part of the apparatus illustrated in FIGS. 1 to 3, the inlets and outlets being illustrated here with connecting elements removed,

FIG. 6 shows a cross section through a sealing unit, such as is used to seal off a shaft with a mixing tool inserted into the mixing vessel,

FIG. 7 shows a basic schematic drawing of the apparatus according to the invention with exemplary connections and

FIG. 8 shows a plan view, analogous to FIG. 2, with a sectioned mixing vessel, the bottom part having been pushed in horizontally and partially here in order to express the mixed product, forming an interior part to which an inert gas can be applied.

### WAYS OF IMPLEMENTING THE INVENTION

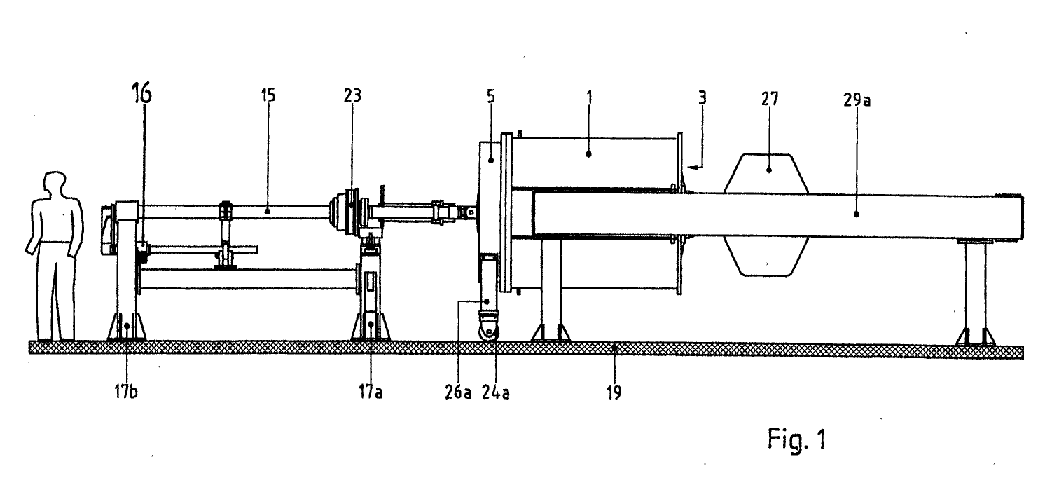

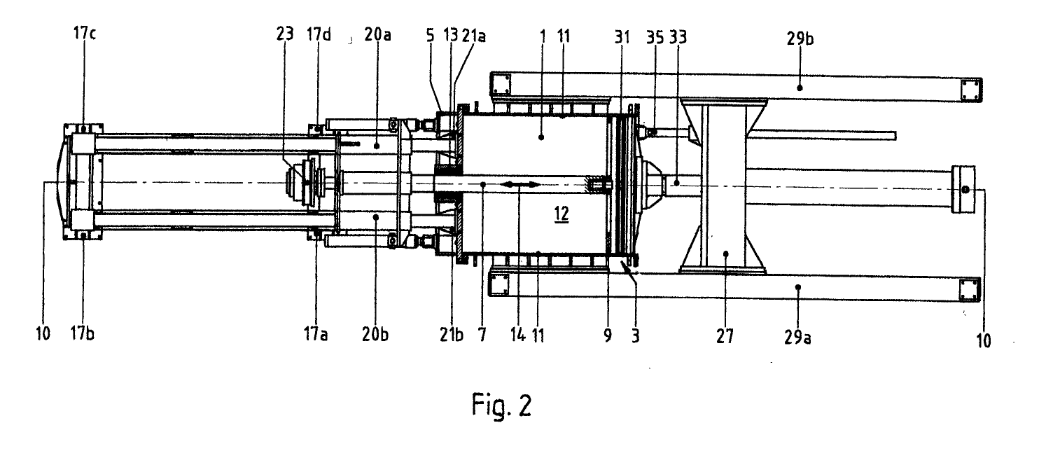

The industrial apparatus for mixing in particular viscous or pasty materials or mixed product, illustrated in FIGS. 1 and 2, has a mixing vessel 1 which is closed off by a bottom part 3 and a top part 5 located opposite the latter. Through the top part 5 there extends a shaft 7 as a linear guide for a mixing tool 9. The shaft 7 is arranged on an approximately horizontal geometric axis 10 of the mixing vessel 1. The inner wall 11 of the interior 12 of the mixing vessel 1 is of circularly cylindrical design and has, for example, a volume between 500 and 2200 liters. The shaft 7 is led through a sealing shaft seal 13 as a sealing unit in the top part 5. The shaft 7, and therefore the mixing tool 9, can be displaced axially in the interior 12 by means of a displacement device 15 that acts horizontally, as indicated by the double arrow 14. Dispersion and fine mixing is completed within 2 to 6 minutes in all products.

The displacement device 15 is fixed to the foundation 19 via four supports 17a to 17d and to the top part 5 by means of two guide shafts 20a and 20b on the outside, with flanges 21a and 21b. In addition, the displacement device 15 has a hydraulic motor 23, as it is known, for the displacement movement of the shaft 7. The guide shafts 20a and 20b provide the guide device 15 with stability against buckling and twisting.

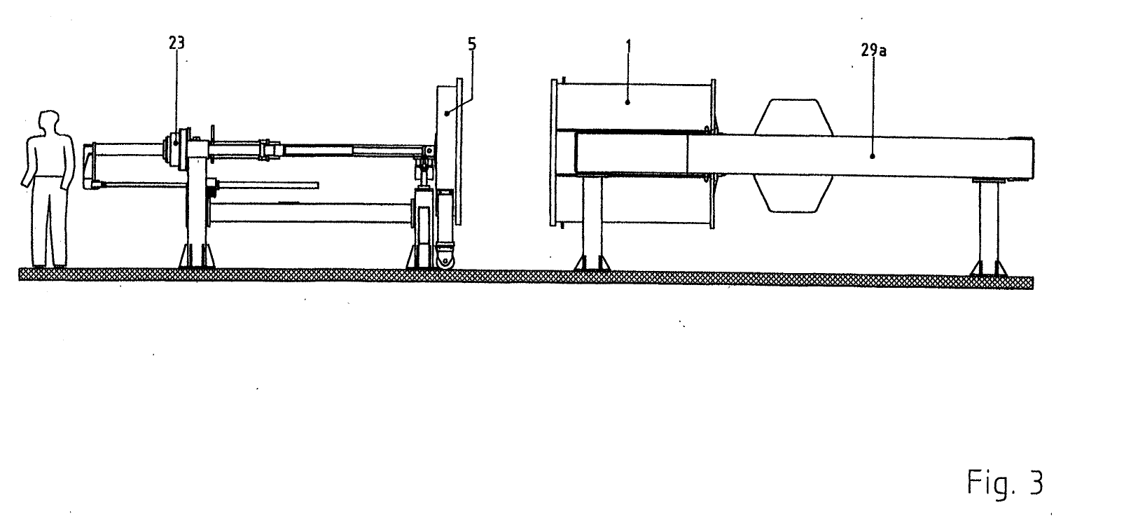

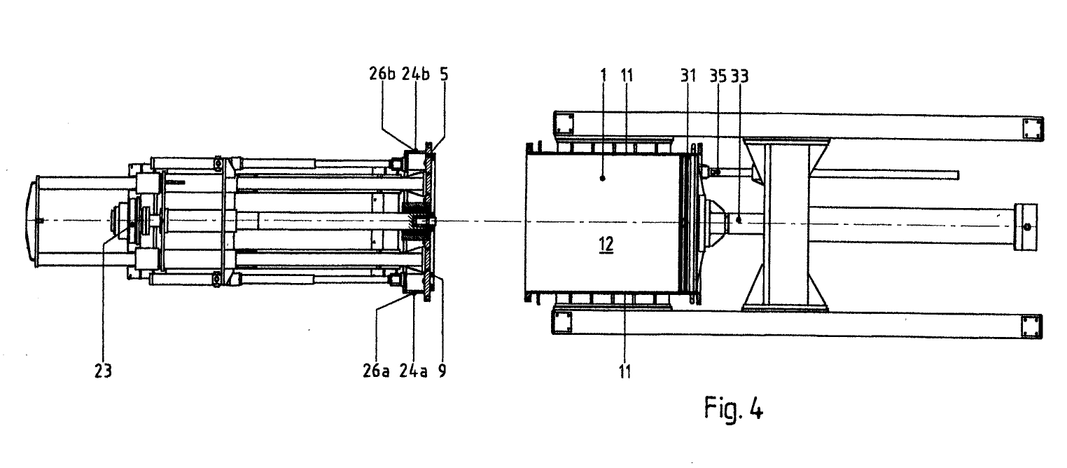

By using a manually operated further displacement device 16, the top part 5 can be removed from the mixing vessel 1 for servicing and cleaning purposes when the securing clamps 25 are released. In this case, the top part 5 rolls on two supports 26a and 26b provided with wheels 24a and 24b. This position is shown in FIGS. 3 and 4.

The bottom part 3 can be displaced horizontally in the axial direction of the mixing vessel 1 (axially) by a displacement device 27. The displacement device 27 is connected to the mixing vessel 1 via lateral supports 29a and 29b on the outside. The two supports 29a and 29b likewise rest on four supports 30a to 30d connected to the foundation 19. The cylindrical bottom part 3 is likewise sealed off with respect to the inner wall 11 at its edges by a sealing unit 31 analogous to the shaft seal 13 of the shafts 7.

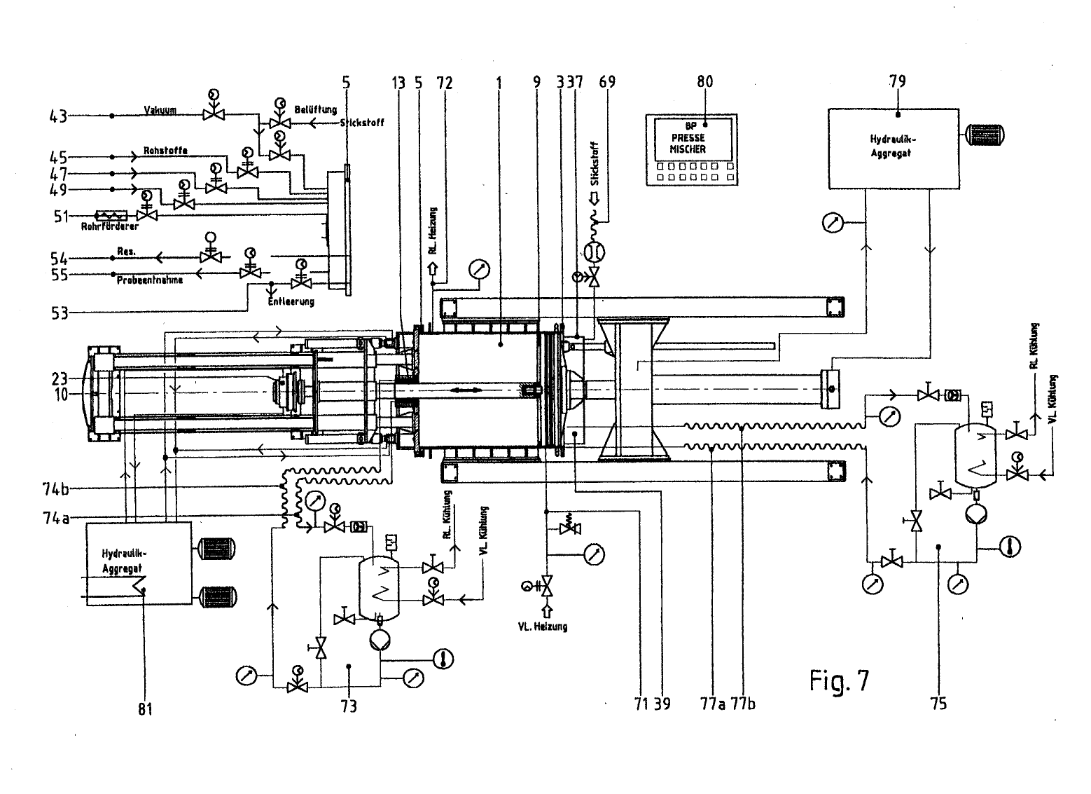

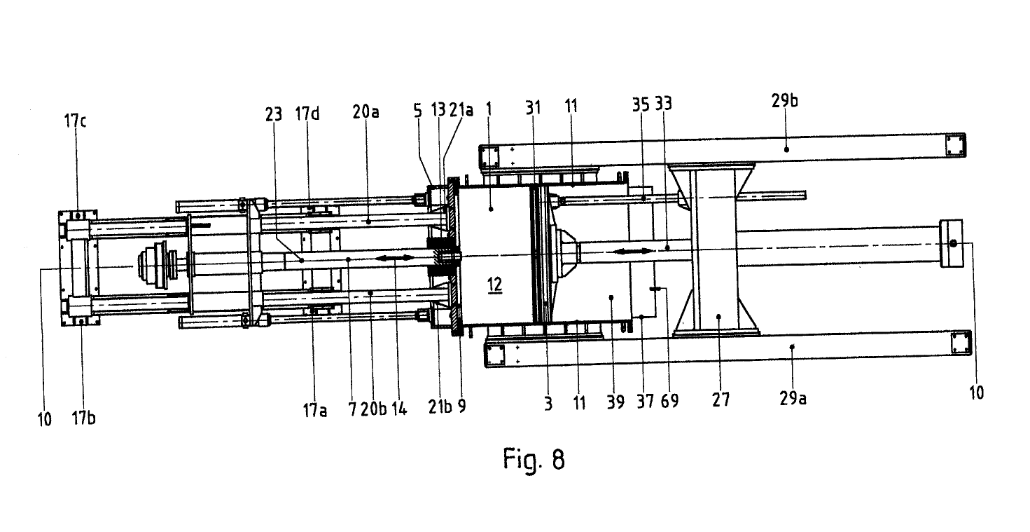

On the geometric axis 10, the displacement device 27 has a shaft 33 for displacing the bottom part 3 for the expression operation of the mixed product. Using an expression pressure of, for example, up to 12 bar, rapid emptying is achieved without the use of pump systems. A small residual quantity is achieved in this way. In order to prevent the bottom plate 3 tilting during the expression, there is a further shaft 35 arranged off-centre. The bottom part 3 is covered by a covering hood 37. The covering hood 37 covers a part 39 of the interior which becomes free during the expression. This interior 39 which becomes free can, as shown in FIG. 8, be filled (flooded) with an inert gas as a gas application via a connection 69 indicated in FIG. 7, in order that no curing, which can be brought about by environmental conditions, can take place of the mixed material that has remained adhering to the inner wall 11.

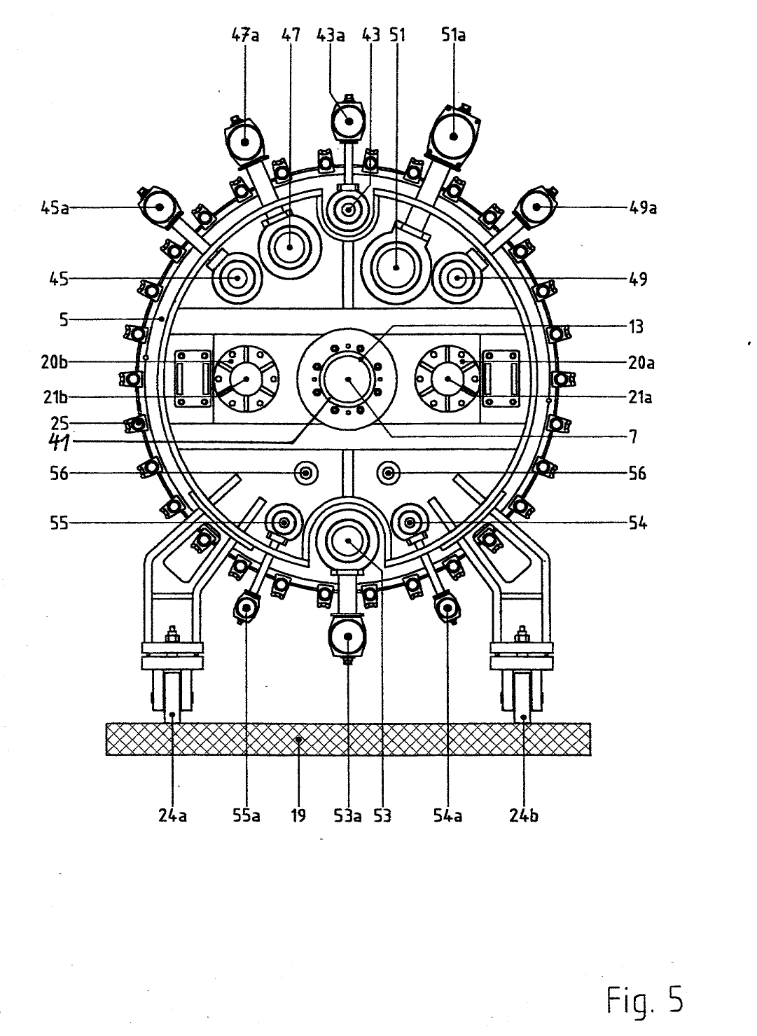

As opposed to EP 0 196 291, here all the inlets relating to the introduction of the materials for the mixed product to be produced, and for leading the finished mixed product out, are arranged on the top part 5. The top part 5 illustrated in FIG. 5 has at its centre a bushing 41 for the shaft 7 which comes to lie on the geometric axis 10 of the mixing vessel. On the left and right of the bushing 41, in each case there is arranged a flange 21a and 21b for the guide shafts 20a and 20b. Above the bushing 41 there is a connection 43 for subjecting the mixing chamber (interior 12) to pressure or vacuum. During the mixing operation and/or in order to eliminate undesired gases, a vacuum down to −1.0 bar, for example, can be applied. On the other hand, the mixing pressure can also be matched appropriately to the product: atmospheric pressure, vacuum and a compression pressure up to, for example, 8 bar.

Materials for the production of the mixed product can be introduced through the connections 45, 47 and 49. For example, a tubular conveyor for the introduction of powdered material can be connected to the connection 51. Arranged underneath the central bushing 41 is the outlet 53 for the mixed product finally mixed by the mixing tool 9. On the left and right beside the outlet 53 there is a spare connection 54 and also a connection 55 for sample removal. The cylinders 43a, 45a, 47a, 49a, 51a, 53a, 54a and 55a located on the outside in FIG. 5 are pneumatic drives belonging to the inlets and outlets 43, 45, 47, 49, 51, 53, 54 and 55.

The bearing packing 63a-d arranged in the bushing 41 for the mixer shaft 7 has been selected to be sufficiently large, in terms of its axial dimension, that it is able to absorb tilting moments which occur during mixing. The shaft seal 31 has the sealing packings 13a and 13b and has a through opening 61 for the shaft 7. Arranged in the end of the sealing packing 13a that is adjacent to the mixing chamber 12 is a first bearing strip 63b, which is followed by three further bearing strips 63a to 63c at a distance which corresponds to approximately half the packing length. Between the sealing packings 13a and 13b there is a purging groove 65. This purging groove 65 is connected to a liquid inlet and a liquid outlet 67a and 67b, respectively. The purging liquid used is a medium compatible with the mixed product.

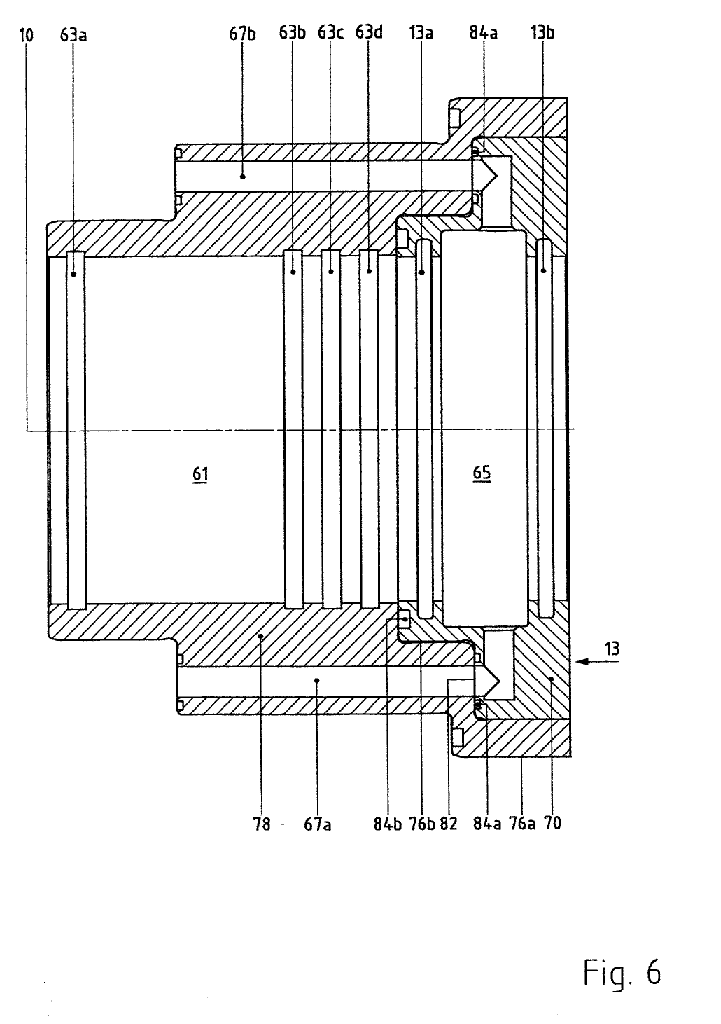

Since the sealing packings 13a and 13b wear more quickly than the bearing strips 63a to 63c, the sealing packings 13a and 13b are arranged in a replaceable sealing-packing carrier 70 belonging to the shaft seal 13. As can be seen in FIG. 6, the sealing-packing carrier 70 has an external contour with two disc-like straight circularly cylindrical external contours 76a and 76b, which are plugged into a corresponding inner contour of the base part 78 of the shaft seal 13. The two external contours 76a and 76b are connected via a wall 82 running at right angles to the geometric axis 10. In this wall, two sealing rings 84a and 84b are arranged in appropriate grooves for the purpose of sealing.

Of course, instead of a circularly cylindrical external contour of the carrier 70, other contours could also be used; this includes those whose external contour prevents rotation.

The carrier 70 can then be fixed to the base part 78 of the shaft seal 13 by screws (not illustrated); however, it can also be designed such that it can be screwed together by means of a thread (not illustrated) on the external contour 76a and 76b and the corresponding inner wall of the base part 78.

FIG. 7 shows a basic circuit diagram of the entire apparatus with the connections necessary for operation. In order to be able to represent the large number of connections at least to some extent in a clear way, the top part 5 is illustrated twice, although only present once. The connections already described previously in the top part 5 for the application 43 of pressure or vacuum, the mixed product outlet 53, the sample removal outlet 55, the spare connection 54, the “powder inlet” 51 and the material inlets 45, 47 and 49 will not be discussed further. The covering hood 37 over the bottom part 3 has a connection 69, here, by way of example, for nitrogen. The nitrogen, as already explained above, is used in order that mixed product which has passed in extremely small quantities into the space 39 between the covering hood 37 and bottom part 3, for example, cannot cure. Leading the nitrogen away or recycling it is not envisaged here; it escapes into the surroundings. If desired, it can of course be led away via a pipe system.

For the purpose of heating (if necessary also cooling) the mixing vessel 1 and the mixed product, there is a feed 71 for a heating fluid on the underside of the mixing vessel 1. This heating fluid is led away from the jacket of the mixing vessel 1 through the connection 72. Managing the process temperature over a wide range is possible without difficulty. For example, products with a maximum permissible mixing temperature of 30° C. can be produced satisfactorily.

The purging liquid for the shaft seal 13 is provided by the plant 73 and fed to the shaft seal 13 via the flexible lines 74a and 74b. There is a similar plant 75 for the purging liquid of the sealing unit 31 of the bottom part 3; the feed is provided via flexible lines 77a and 77b. The mixed product is expressed by means of a hydraulic plant 79, which is adjustably controlled by a computer 80. An analogous plant 81 is used to drive the mixer shaft 7 with the mixing tool 9.

By virtue of a closed system, the apparatus is optimally suitable for a batch-in-batch production system. If a product change is necessary, the down time is short, as a result of the high level of self-cleaning and simple cleaning of residues.

The mixing and expressing apparatus described above is suitable in particular for the production (mixing) of viscous or pasty materials (compounds); however, it is also possible to use it to mix low-viscosity materials and then to expel them into containers. Since the apparatus can be produced for different mixed product with different viscosity and different filling capacity for the mixing vessel, the dimensions and total weight relationships of the apparatus also change. If, for example, silicone-like sealing compounds are produced, then an apparatus of this type can certainly have a length of 10 meters and a height of barely 3 meters with a total weight of about 20 tonnes.

In the explanations above, curing is explained as a chemical process with the ambient air. Here, this expression represents all the possible chemical processes which can take place with the ambient air, the ambient temperature or other events. Above, nitrogen is specified as the inert gas in the chamber 39. Of course, other inert gases can also be used. The gas to be used depends on the characteristics of the mixed product.

In summary, the apparatus described above, with its design variants, has a broad range of applications, an extremely short mixing time, reliable temperature management, high mixing efficiency under compressive pressure, rapid emptying without additional units and an efficiency by virtue of a high level of self-cleaning and low expenditure on cleaning residues.

1. Apparatus for industrial mixing of in particular viscous or pasty materials in a mixing vessel (1) and for industrial expulsion of the mixed product produced from this vessel (1), the mixing vessel (1) being closed by a bottom part (3) and a top part (5) opposite the latter and there being in the mixing vessel (1) a movable mixing tool (9) whose position can be varied, characterized in that the axis (10) of the mixing vessel is arranged approximately horizontally, through the top part (5) of the mixing vessel (1) there extends a linear guide (7) with which the mixing tool (9) can be moved, varying its position, and the bottom part (3) is designed to be displaceable towards the top part (5) in order to expel the mixture in the mixing vessel (1).

2. Apparatus according to claim 1, characterized in that the bottom part (3) is designed such that it can be moved approximately horizontally in order to expel the mixture.

3. Apparatus according to claim 1 or 2, characterized by inlets (45, 47, 49, 51), which can preferably be closed by valves, in the top part (5), through which materials for the mixed products can be introduced, by in particular a connection (43) for the application of pressure or vacuum and, primarily, an outlet (53) through which the mixed product can be expelled from the mixing vessel (1) into containers.

4. Apparatus according to one of claims 1 to 3, characterized by a covering hood (37), which seals off from the outside the part (39) of the interior of the vessel which becomes free as the mixed product is expelled by the displaced bottom part (3), preferably permits the application of a gas with respect to the surroundings, and also an inlet (69) for an inert gas into this interior (39) of the vessel that becomes free, in order that no reaction of the mixed product adhering to the inner wall (11) can occur as a result of ambient conditions.

5. Apparatus according to one of claims 1 to 4, characterized in that the lateral vessel wall (11) can be subjected to a predefined temperature.

6. Apparatus according to one of claims 1 to 5, characterized in that the interior (12) of the mixing vessel is designed as a circular cylinder, the bottom part (3) is preferably secured against rotation and in particular against tilting and is designed to be displaceable, in particular by means of a shaft (33) that acts axially, and, primarily, securing the rotation and in particular the tilting of the bottom part (3) is performed by at least one further coaxial shaft (35) arranged off-centre.

7. Apparatus according to one of claims 1 to 6, characterized in that the linear guide (7) extending through the top part (5) has a purged sealing unit (13), which preferably has a sealing-packing carrier (70), arranged in the top part (5) such that it can be replaced, to accommodate the sealing packings (13a, 13b).

8. Apparatus according to one of claims 1 to 7, characterized in that the bottom part (3) has a purged sealing unit (31).

9. Apparatus according to one of claims 1 to 8, characterized in that the top part (5) is designed such that it can be removed from the mixing vessel (1) for cleaning and servicing work.
